(19) United States
(12) Patent Application Publication
(10) Pub. No.: US 2006/0061922 A1
(43) Pub. Date: Mar. 23, 2006

(54) Hybrid power supply system having energy storage device protection circuit

(75) Inventors: Rasvan Catalin Mihai, Vancouver (CA); Eugene Andrei Trandafir, Port Moody (CA); David Leboe, Vancouver (CA)

Correspondence Address: L. Grant Foster;HOLLAND & HART LLP, 555 - 17th Street, Suite 3200, P.O. Box 8749, Denver, CO, 80201, US

(73) Assignee: Cellex Power Products, Inc.

(21) Appl. No.: 10/947,038

(22) Filed: Sep. 22, 2004

(51) Int. Cl. H02H 7/06

(52) U.S. Cl. 361/20

(57) ABSTRACT

This application relates to an energy storage device protection circuit for use in a hybrid system supplying power to an active dynamic DC load, such as an electric vehicle drive. The circuit prevents over-discharge of the energy storage device and ensures that the system will be capable of delivering a minimum acceptable level of power to the load, even when the energy storage device is in a low state of charge or other de-rated mode. The hybrid system includes a power generator such as fuel cell capable of supplying at least the average power value requirements of the load and an energy storage device such as a battery or capacitor capable of supplying at least the difference between the peak power requirements of the load and the average power value. A controller is provided for controlling the relative supply of power to the load from the power generator and the energy storage device. The protection circuit is in series with the energy storage device and may include a first switch controllable by the controller, a diode in parallel with the first switch and optionally a current-limiting impedance in parallel with the first switch. The system may be implemented in lift trucks and the like to prevent overdriving of the vehicle in a low state of charge condition while permitting the operator to safely return the vehicle to a service location. The system regulates the output of the fuel cell in both the normal and de-rated operating modes to avoid load-following operation.

### TECHNICAL FIELD

This application relates to an energy storage device protection circuit for use in a hybrid electrical system supplying power to an active dynamic DC load, such as an electric vehicle. The circuit prevents over-discharge of the battery or other energy storage device and ensures that the system will be capable of delivering a minimum acceptable level of power to the load, even when the energy storage device is in a low state of charge or other fault condition.

### BACKGROUND OF THE INVENTION

Hybrid power supply systems are well known in the prior art for supplying power to loads having fluctuating power requirements. For example, a hybrid power supply system for use in non-road electric vehicles, such as lift trucks and the like, is described in applicant's co-pending U.S. patent application Ser. No. 10/684,622 which is hereby incorporated by reference in its entirety. Lift trucks have a duty cycle that is characterized by loads which fluctuate substantially during the course of a work shift. For example, although the average load across an entire seven hour work shift may be less than 1 kW, power requirements on the order of 8-10 kW for short durations are required to meet operational demands, often at irregular intervals. Even though the average power requirement of the lift truck is relatively low, the power supply system must nonetheless be capable of responding to high current requests from the lift truck. This type of load profile is sometimes referred to as an active dynamic load.

The Applicant has developed a hybrid architecture specifically adapted for lift trucks and other low power applications which integrates fuel cell technology with conventional battery systems. According to this architecture the fuel cell is sized to meet the average load requirements of the vehicle, while the batteries or other energy storage devices and power control hardware are capable of responding to very high instantaneous load demands. Preferably the state of charge of the energy storage device(s) is maintained at a level sufficient to meet the peak power requirements. Problems may potentially arise, however, in the case of malfunction of power system components. For example, if a battery becomes low in residual charge or is over-discharged, intervention is required to protect the battery before a critical point is reached beyond which damage to the battery or a severe loss of system performance will occur. In such circumstances it is desirable to operate the hybrid power supply system in a de-rated mode sufficient to return the energy storage system to its useful state or to return the vehicle to a service location. It is also desirable to employ a system which cannot be overridden by operators wishing to continue to operate the vehicle in other than the de-rated mode (such as by ignoring warning signals). Further, it is particularly desirable to avoid operating the hybrid power generator (i.e. fuel cell) in a load-following mode while at the same time permitting recharging of the battery by means of the hybrid power generator and regenerative braking or the like.

Different circuits and methods have been proposed in the prior art to protect batteries if voltage exceeds predetermined safe levels, an over-temperature threshold is reached or over-discharge occurs. Many of these systems involve disconnecting the battery from the load or introducing some in-line impedance that will provide a limited power to the load. Typically, in the case of faulty battery operation in a vehicle, the operator is warned by an alarm signal. However, in many prior art applications if the load is increasing and demanding more current, the output voltage of the power supply system could drop below levels required for safe vehicle operation.

Some stand-alone systems are known in the prior art which do not permit the power supply system to continue to service the load in a de-rated mode. The need has arisen for a battery protection circuit adapted for use in hybrid systems supplying power to an active dynamic load which ensures ongoing operation of the system in a de-rated mode. In addition, while in this de-rated, the system ensures that the normal state of charge of the energy storage device can be restored and that the power generator output remains controllable by the system independent of the active dynamic load. The system continues to deliver power to the load while the battery is in a low state of charge condition by routing power from the power generator directly to the load and protecting the battery or other energy storage device at the same time, allowing the operator to continue operations with limited use of the vehicle until such a time where sufficient energy has been restored to the energy storage device and the power system returns to its normal mode of operation. The system also controls the output of the power generator so that the power generator is not required to operate in a load-following manner during either normal operation or in the de-rated mode.

### SUMMARY OF THE INVENTION

In accordance with the invention, a hybrid power supply system for delivering power to a load is provided. The system includes a power generator and an energy storage device electrically connectable to the load and a protection circuit in series with the energy storage device, the circuit comprising a first switch adjustable between open and closed positions and a diode in parallel with the switch. A controller is provided for controlling the relative supply of power to the load from the power generator and the energy storage device. The system may also optionally include an impedance in parallel with the switch.

The system may be used as a power supply in an electric vehicle having an active dynamic load. The energy storage device may comprise, for example, one or more batteries, capacitors, supercapacitors or ultracapacitors. The power generator may comprise a fuel cell.

The system is operable in a normal operating mode and in a de-rated operating mode. The controller maintains the switch in a closed position in the normal operating mode and opens the switch in the de-rated operating mode. Preferably a sensor is also provided which is operatively coupled to the controller. The controller switches the system from the normal operating mode to the de-rated mode when the sensor detects a predetermined operating condition. For example, the sensor could monitor at least one parameter related to the state of charge of the energy storage device and detect the predetermined operating condition when a predetermined threshold value is reached. The at least one parameter could, for example, be voltage, current, temperature, internal resistance and chemistry change.

Preferably the power output of the power generator, such as a fuel cell, is maintained substantially constant in both the normal and de-rated operating modes independently of the power requirements of the load. Accordingly, the fuel cell is not required to operate in a load-following manner in either the normal or the de-rated mode.

A method of controllably delivering power to an active dynamic load having a peak power value and an average power value is also described. The method includes the steps of (a) providing a hybrid power supply system comprising a DC power generator capable of supplying at least the average power value to the load and an energy storage device capable of supplying at least the difference between the peak power value and the average power value to the load; (b) monitoring the operation of the energy storage device to determine whether the energy storage device is in a normal mode or a de-rated mode; and (c) controllably limiting the current discharged from the energy storage device when the sensor detects the de-rated mode. The current may be limited by preventing current discharge entirely or by limiting the amount of current discharged via an impedance.

The energy storage device may be controllably chargeable in the de-rated mode, for example through a diode. Both the power generator and the diode may be electrically connected to the load in the de-rated mode.

The method may comprise providing a protection circuit in series with the energy storage device, the circuit having a first switch adjustable between an open and a closed position. The step of controllably limiting the current may comprise adjusting the first switch between the closed and open positions. The method may also include the step of detecting when the energy storage device is in the de-rated mode, such as by monitoring at least one parameter related to the state of charge of the energy storage device.

### BRIEF DESCRIPTION OF THE DRAWINGS

In drawings which illustrate various embodiments of the invention but should not be construed as restricting the spirit or scope of the invention in any way,

FIG. 1 is a schematic view illustrating a prior art hybrid power system comprising a power generator, an energy storage device and an active dynamic load.

FIG. 2 is a graph illustrating an active dynamic load cycle that either draws power from or delivers power to the hybrid system of FIG. 1.

FIG. 3(a) illustrates a hybrid system modified in accordance with the invention for protecting the battery from over-discharge showing the system operating in a normal mode.

FIG. 3(b) illustrates the hybrid system of claim 3(a) operating in a de-rated mode.

FIG. 4 illustrates an alternative embodiment of hybrid power supply system that enables controlled charging and controlled discharging of the energy storage device.

FIG. 5 illustrates a further alternative embodiment of the invention similar to the embodiment of FIG. 4 that enables the energy storage device to be electrically isolated from the load.

### DETAILED DESCRIPTION

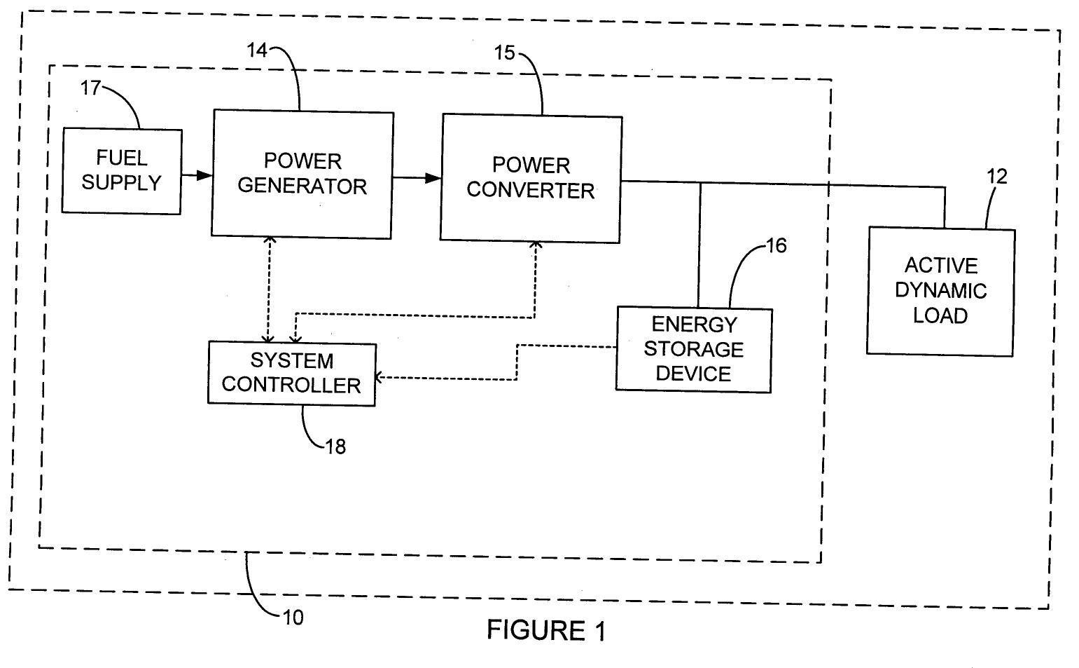

FIG. 1 is a schematic view of a hybrid power supply system 10 of the prior art for delivering power to an active dynamic load 12. For example, power supply system 10 could supply power to a forklift truck drive or other similar load 12. Hybrid power supply system 10 comprises a power generator 14, a power converter 15, an energy storage device 16 and a system controller 18. Preferably power generator 14 is sized to provide the average power requirements of the load and energy storage device 16 is sized to provide at least the peak power requirements. For example, power generator 14 may comprise a fuel cell receiving fuel from a fuel supply 17. Power converter 15 adapts the power generated by generator 14 to a DC format suitable for use by load 12. Energy storage device 16 may comprise one or more batteries, capacitors, supercapacitors or ultracapacitors. System controller 18 controls the delivery of power from power generator 14 and/or energy storage device 16 depending upon the changing power requirements of load 12 and/or the changing state of energy storage device 16.

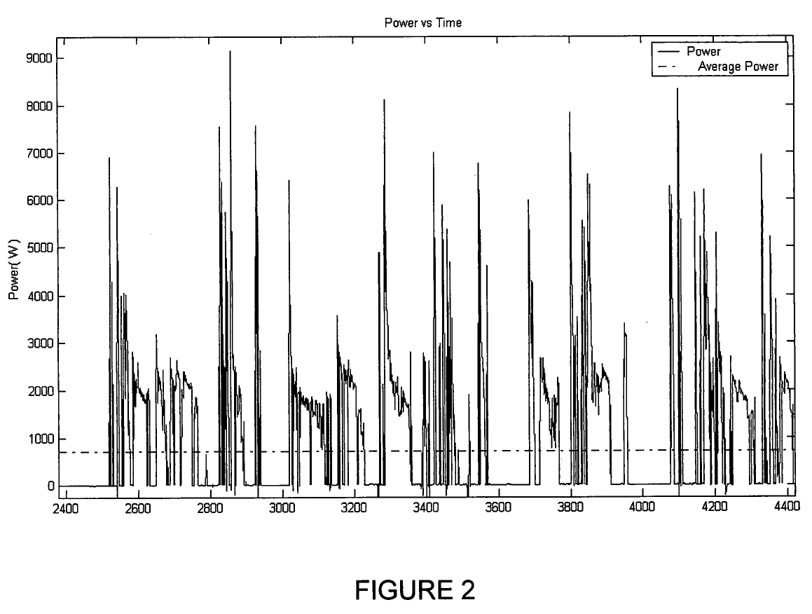

FIG. 2 graphically illustrates an active dynamic electric load cycle. As used in this patent application, “active dynamic load” means a load 12 which fluctuates at regular or irregular intervals during an operating session. Load 12 may draw or deliver current during an operating session. More particularly, the load cycle comprises a positive peak power value that is drawn from the hybrid system 10; a negative peak power value that is fed back to the hybrid system 10; and an average power value that may, for example, approximate the minimum amount of power required (such as the power required to start an electric vehicle and keep it moving). The average load value may be determined using different averaging methods, such as root mean square, mean power level or by any other averaging method suitable for the particular application. Load 12 may comprise, for example, a vehicular motor or motor/generator.

By paralleling the output of power generator 14 and energy storage device 16, system 10 is capable of delivering the required power to active dynamic load 12 over the application period, namely:
P load=P power generator+P energy storage device

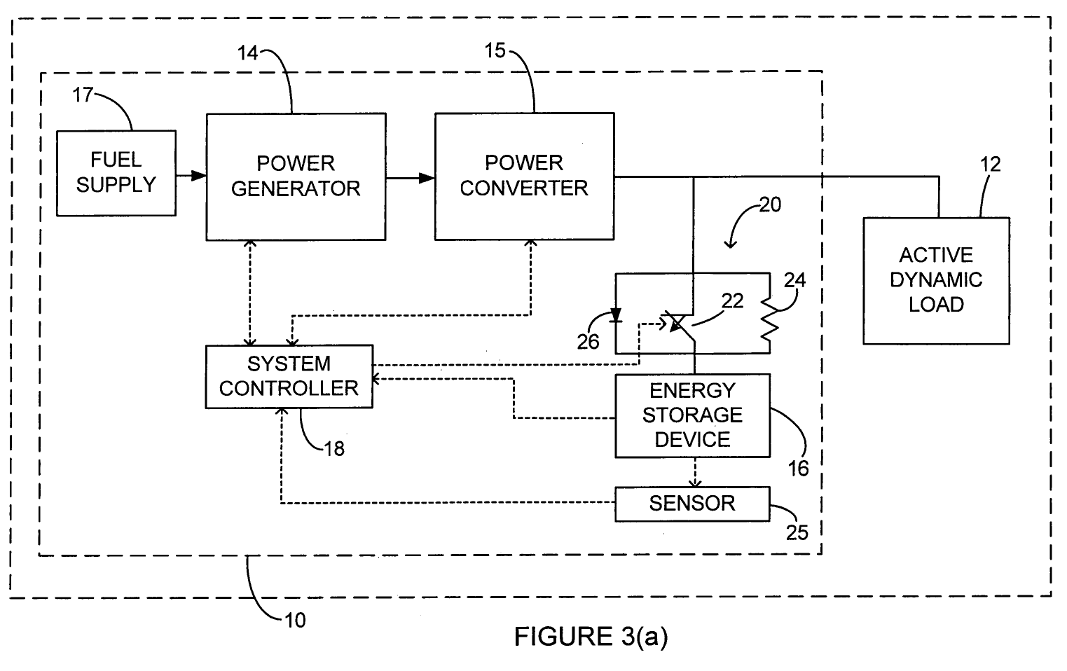

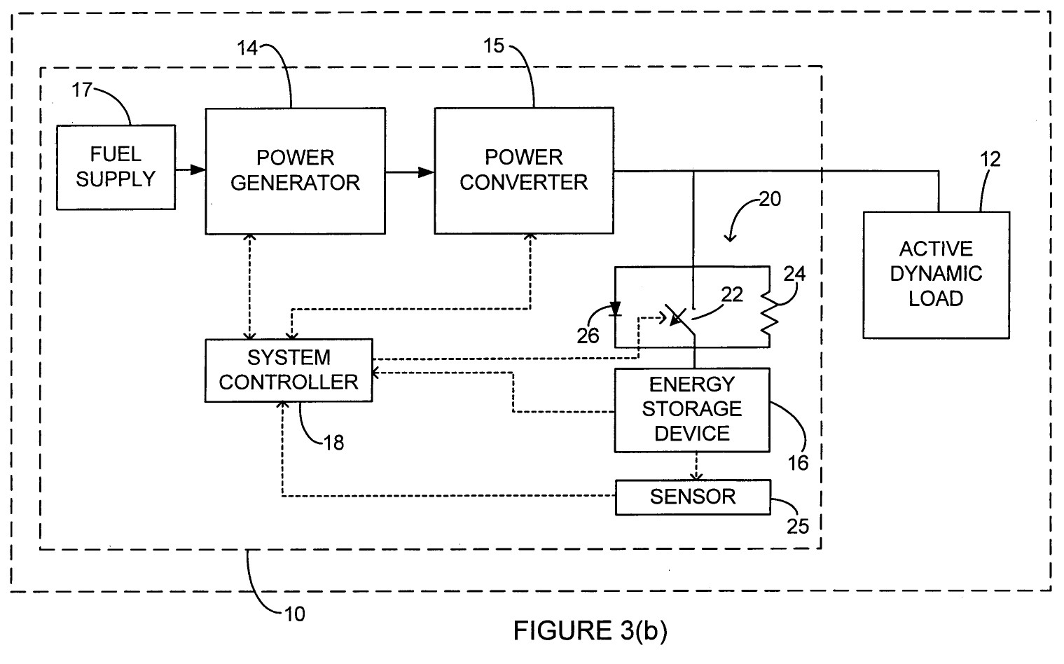

However, problems may arise if a fault condition arises and the energy storage device 16 is unable to safely meet the peak load requirements. For example, when the state of charge of energy storage device 16 is low or some other fault condition arises, such as current overloading, rapid discharge or under voltage, this may cause damage to storage device 16 or severely limit system performance if allowed to continue. In order to protect energy storage device 16 in the event of a fault condition, or some other predetermined operating condition, a protection circuit 20 is provided. As shown in FIGS. 3(a) and 3(b), circuit 20 is in series with energy storage device 16. In the simplest case, circuit 20 includes a switch 22 in parallel with a diode 26. In a further embodiment, circuit 20 also includes an impedance 24 in parallel with a switch 22. As described herein, protection circuit 20 controllably limits the current discharged by energy storage device 16. In the case where circuit 20 comprises switch 22 and diode 26 only, the discharge current may be limited to a zero value—i.e. no current may be discharged. In the case where impedance 24 is provided, the current discharged will be controllably limited via impedance 24.

Circuit 20 is configured to protect the integrity of both energy storage device 16 and power generator 14. In one embodiment of the invention, protection circuit 20 does not entirely disconnect energy storage device 16 from load 12 so that the entire load is not transferred to power generator 14 if a fault condition or some other predetermined operating condition arises.

In normal operation switch 22 is closed (FIG. 3(a)), diode 26 and impedance 24 are bypassed and the output of energy storage device 16 is provided to load 12 in parallel with power generator 14 operating at the same voltage (energy storage device 16 ordinarily clamps the output voltage of power converter 15). When a monitor or sensor 25 determines an energy storage device alarm or fault, switch 22 is opened and diode 26 is now introduced in-line with the battery as shown in FIG. 3(b). In the case of the alternate embodiment, impedance 24 is also introduced in parallel with diode 26. In the case of the de-rated mode where impedance 24 is introduced, energy storage device 16 remains electrically connected to load 12 but discharge currents will be limited. Charge currents will flow through diode 26 and will therefore not be limited, allowing energy to be returned to energy storage device 16. Where only diode 26 exists in the simplest case, discharge currents from energy storage device 16 will be prevented entirely while charge currents will still be accepted through diode 26. In this case, the load will be limited to the power available from power generator 14. In the preferred embodiment, power converter 15 is configured such that the input power from power generator 14 is controllable by the system (e.g. system controller 18) and the output current can be limited to a maximum value. This configuration allows load 12 to draw directly from power generator 14 but will be limited to the cutoff current limit should load 12 demand more.

Thus in the de-rated mode the system maintains control of the output of power generator 14. When the demand of load 12 is high, it will draw from the available power of power generator 14 and when the power demand of load 12 is low, current will be delivered to the battery or other energy storage device 16. This enables power generator 14 to continue to operate in a controlled manner without having to respond to load 12 in a load following mode while the system is de-rated.

In the illustrated embodiment opening and closing of switch 22 is controlled by system controller 18. Controller 18 may, for example, comprise a microprocessor configured to receive state of charge, temperature or voltage data from energy storage device 16 and/or sensor 25. As will be appreciated by a person skilled in the art, a circuit having standard analog or digital components could be utilized instead of a microprocessor to provide the required switching controls.

As will also be appreciated by a person skilled in the art, impedance 24 could be a fixed or a variable impedance device (such as a PWM controlled resistor or a MOSFET in the linear portion of its characteristic) that is sized to protect against battery short circuit. Switch 22 may be actuated automatically or manually and could consist of field effect transistor (FET). Diode 26 could consist of any suitable device for conducting current only in the direction toward energy storage device 16.

In operation, system controller 18 will control the power available from power generator 14 by setting a current limit at the input of power converter 15. Power converter 15 will maintain the current from power generator 14 constant and is designed to handle a wide range of output voltages on the active dynamic load 12 without exceeding the current limit set for power generator 14 by system controller 18. Several possible operating states are possible. In a first instance, active dynamic load 12 may be disconnected from power supply system 10. In this case, output power converter 15 will charge energy storage device 16. Current in energy storage device 16 may be determined by the power available at the output of power converter 15 divided by the output voltage of power converter 15.

In another possible operating state, active dynamic load 12 may be receiving less power than is delivered by power converter 15. The difference between power delivered by power converter 15 and power consumed by active dynamic load 12 will be used to charge energy storage device 16. Output current of power converter 15 is determined by the ratio between the output power and voltage.

In another possible operating state, active dynamic load 12 may require more power than is delivered by power converter 15. In this case two possible scenarios are possible. In the first scenario, if the voltage on load 12 exceeds the protection limit of power converter 15, the current on the output of power converter 15 is determined by the ratio between its output power and voltage on load 12. The additional required current will be provided by energy storage device 16 through switch 22 (normal operation) or impedance 24 (abnormal, de-rated operation). In the second scenario, voltage on the load may be very low due to an overload or possible short circuit condition. In this case power converter 15 will limit output current. Current from energy storage device 16 will be limited by impedance 24 and power converter 15 will deliver constant current to load 12. It is possible that current from power generator 15 will drop under the prescribed value in this case. The voltage of energy storage device (V_{ESD}) and current of the energy storage device (I_{ESD}) will not drop under a safe limit that is specific to the electrochemistry of the battery or other energy storage device 16 in question.

When energy storage device 16 is in a faulty or de-rated mode as shown in FIG. 3(b), the output characteristic of hybrid system 10 is limited by the capabilities of power generator 14. System 10 could continue to operate in the de-rated mode so long as fuel is supplied to power generator 14 from fuel supply 15. Thus the capacity of power supply system 10 to supply power to load 12 sufficient to meet the average load requirements is not altered by the change in status of energy storage device 16. If load 12 decreases and draws less power, under the power level provided by generator 14, the extra energy is used to charge energy storage device 16 through diode 26 if switch 22 is open. Since energy storage device 16 remains connected to load 12 in the de-rated mode of FIG. 3(b), energy recovery to energy storage device 16 by means of regenerative braking and the like is also possible. Also, the operational integrity of power generator 14, such as a fuel cell, is maintained since it is not required to service the entire load 12, even in the de-rated mode.

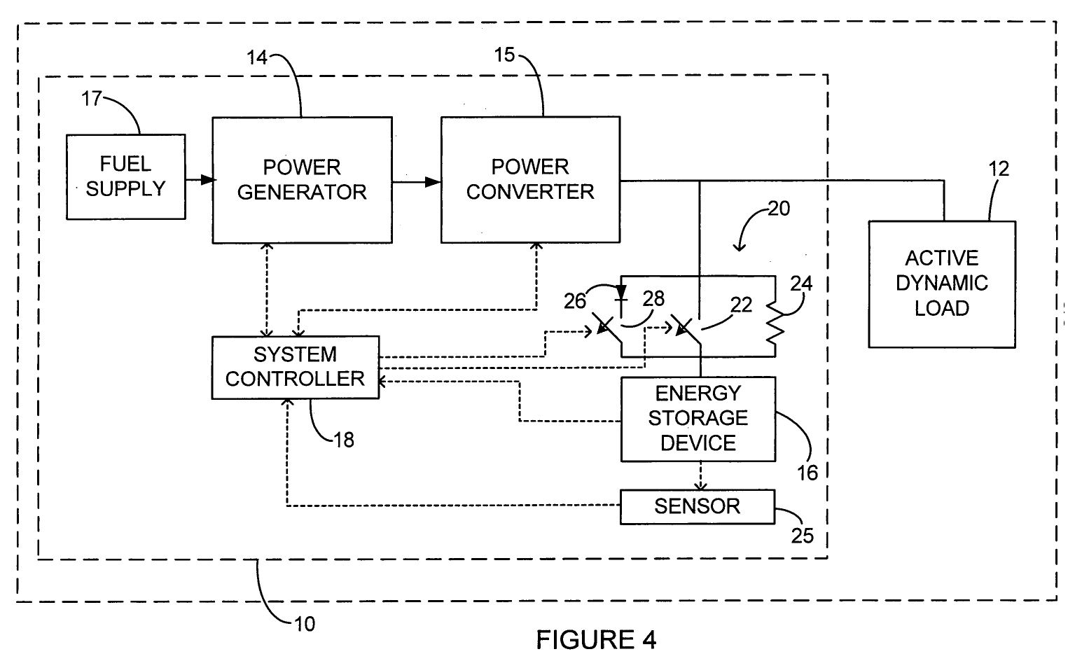

FIG. 4 illustrates an alternative embodiment of the invention where circuit 20 has been modified to include a second switch 28 in series with diode 26. System controller 18 controls the operation of switch 22 and switch 28 depending upon the status of energy storage device 16 to protect against both over-charge and over-discharge. For example, if system 10 is operating in the normal mode in the absence of a peak load and energy storage device 16 is fully charged, both switches 22 and 28 could be opened to protect device 16 against over-charge. Alternatively, if system 10 is in the de-rated mode, switch 22 could be open and switch 28 could be closed. This would prevent over-discharge of energy storage device 16 while at the same time permitting energy recovery by regenerative braking or the like, as discussed above.

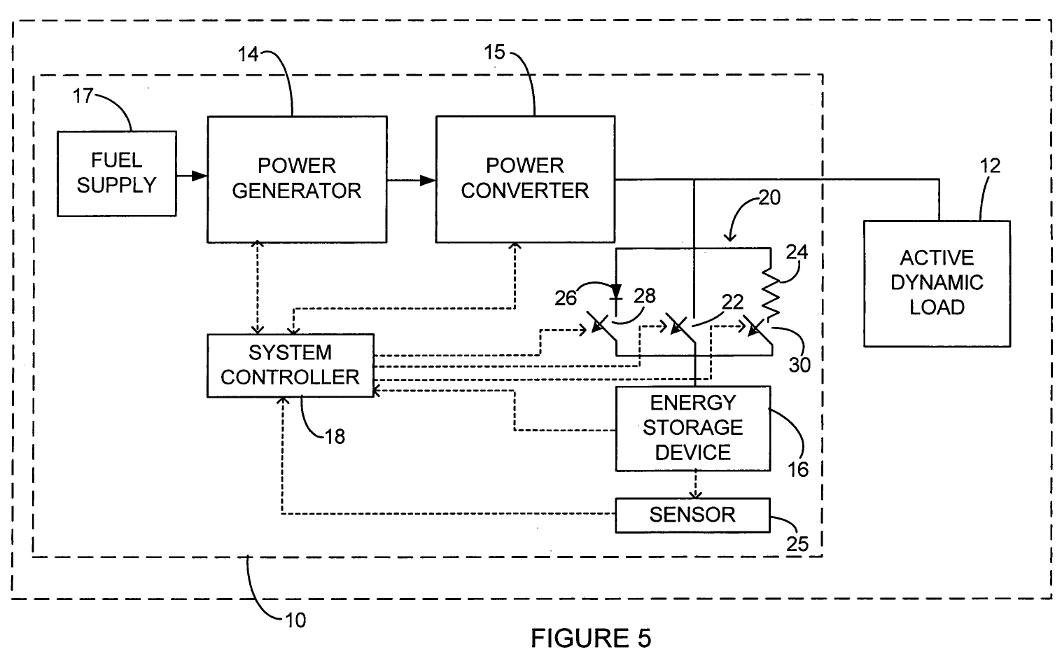

FIG. 5 illustrates a further alternative embodiment of the invention which includes a third switch 30 in series between energy storage device 16 and impedance 24. Switch 30 enables energy storage device to be electrically isolated entirely from load 12 (i.e. when all switches 22, 28, 30 are open as in FIG. 5). For example, the peak power supplied by the energy storage device 16 could be reduced to zero and the dynamic load 12 will only be able to draw its average power requirements from power generator 14 and/or a secondary energy storage device (not shown). The operation of each of the switches 22, 28, 30 is managed by controller 18 depending upon sensed operating parameters.

As will be apparent to those skilled in the art in the light of the foregoing disclosure, many alterations and modifications are possible in the practice of the invention without departing from the spirit or scope thereof. Accordingly, the scope of the invention is to be construed in accordance with the substance defined by the following claims.

1. A hybrid power supply system for delivering power to a load comprising:
(a) a power generator electrically connectable to said load;
(b) an energy storage device electrically connectable to said load;
(c) a protection circuit in series with said energy storage device, wherein said circuit comprises a first switch adjustable between open and closed positions and a diode in parallel with said switch; and
(d) a controller for controlling relative supply of power to said load from said power generator and said energy storage device, wherein said first switch is controllable by said controller.

2. The system as defined in claim 1, further comprising an impedance in parallel with said switch.

3. The system as defined in claim 1, wherein said system is operable in a normal operating mode and in a de-rated operating mode, wherein said controller maintains said switch in a closed position in said normal operating mode and opens said switch in said de-rated operating mode.

4. The system as defined in claim 3, further comprising at least one sensor operatively coupled to said controller, wherein said controller switches said system from said normal operating mode to said de-rated mode when said sensor detects a predetermined operating condition.

5. The system as defined in claim 4, wherein said sensor monitors at least one parameter related to the state of charge of said energy storage device and detects said predetermined operating condition when said condition reaches a threshold.

6. The system as defined in claim 5, wherein said at least one parameter is selected from the group consisting of voltage, current, temperature, internal resistance and chemistry change.

7. The system as defined in claim 3, wherein said diode permits recharging of said energy storage device in said normal and said de-rated operating modes.

8. The system as defined in claim 3, wherein said energy storage device is selected from the group consisting of at least one battery, capacitor, supercapacitor and ultracapacitor.

9. The system as defined in claim 3, wherein said power generator comprises a fuel cell.

10. The system as defined in claim 1, further comprising a power converter electrically connected between said power generator and said load.

11. The system as defined in claim 9, wherein the power output of said fuel cell is maintained substantially constant in said normal and said de-rated operating modes independently of the power requirements of said load.

12. An electric vehicle having an active dynamic load, wherein said vehicle comprises a hybrid power supply system as defined in claim 1 for supplying power to said load.

13. A method of controllably delivering power to an active dynamic load having a peak power value and an average power value comprising:
(a) providing a hybrid power supply system comprising a DC power generator capable of supplying at least said average power value to said load and an energy storage device capable of supplying at least the difference between said peak power value and said average power value to said load;
(b) monitoring the operation of said energy storage device to determine whether said energy storage device is in a normal operating mode or a de-rated operating mode; and
(c) controllably limiting the current discharged from said energy storage device when said energy storage device is determined to be in said de-rated mode.

14. The method as defined in claim 13, wherein said energy storage device is controllably chargeable in said de-rated mode.

15. The method as defined in claim 14, wherein said energy storage device is controllably chargeable via a diode.

16. The method as defined in claim 13, wherein said energy storage device is controllably dischargeable.

17. The method as defined in claim 13, wherein said energy storage device is controllably dischargeable via an impedance.

18. The method as defined in claim 13, wherein said power generator and energy storage device are electrically connected to said load in said de-rated mode.

19. The method as defined in claim 13, wherein the step of controllably limiting the current discharged from said energy storage device comprises switching current flow from a short circuit to an electrical connection through an impedance.

20. The method as defined in claim 13, wherein said system comprises a protection circuit in series with said energy storage device, said circuit having a first switch adjustable between an open and a closed position.

21. The method as defined in claim 20, wherein said step of controllably limiting said current comprises adjusting said switch from said closed to said open position.

22. The method as defined in claim 20, wherein said protection circuit comprises an impedance in parallel with said first switch, wherein said step of controllably limiting said current comprises adjusting said first switch from said closed to said open position and permitting a limited discharge from said energy storage device through said impedance.

23. The method as defined in claim 13, wherein said power generator supplies at least said average power value to said load in said de-rated mode.

24. The method as defined in claim 13, comprising the step of detecting that said energy storage device is in said de-rated mode when at least one parameter related to the state of charge of said energy storage device reaches a predetermined threshold value.

25. The method as defined in claim 24, wherein said parameter is selected from the group consisting of voltage, current, temperature internal resistance and chemistry change.

26. The method as defined in claim 13 wherein said power generator is a fuel cell and wherein the power output of said fuel cell is maintained substantially constant in said normal and said de-rated operating modes independently of the power requirements of said load.
